(19) United States
(12) Patent Application Publication
(10) Pub. No.: US 2024/0177185 A1
(43) Pub. Date: May 30, 2024

(54) SYSTEM AND METHOD FOR BLOCKCHAIN-BASED DATA CROWDSOURCING AND DISTRIBUTION

(71) Applicant: ATAD CORP., Seoul (KR)

(72) Inventor: Yeong Seon PARK, Gwangju (KR)

(21) Appl. No.: 18/469,250

(22) Filed: Sep. 18, 2023

(30) Foreign Application Priority Data
Nov. 28, 2022 (KR) 10-2022-0161123

(51) Int. Cl. G06Q 30/0208; G06Q 20/38; G06Q 30/0601

(52) U.S. Cl. CPC G06Q 30/0208; G06Q 20/389; G06Q 30/0635

(57) ABSTRACT

A system and method for blockchain-based data crowdsourcing and distribution source supply of data suitable for a purpose to a plurality of crowd providers according to a request from a purchaser, and automatically calculate and pay a different royalty for each subject of a provider, a processor, an inspector, and an immediately previous purchaser according to quality of provided data, a rate of data loss due to non-consent to resale during a distribution process, and contribution of a processor and/or an inspector involved in a provision process.

### CROSS-REFERENCE TO RELATED APPLICATIONS

This application claims priority from Korean Patent Application No. 10-2022-0161123, filed on Nov. 28, 2022, in the Korean Intellectual Property Office, which is incorporated herein by reference in its entirety.

### BACKGROUND OF THE INVENTION

### Field of the Invention

The present invention relates to a system and method for blockchain-based data crowdsourcing and distribution, and more particularly to a system and method for data crowdsourcing and distribution for sourcing supply of data suitable for a purpose to a plurality of crowd providers according to a request from a purchaser, and automatically calculating and paying a different royalty for each subject of a provider, a processor, an inspector, and an immediately previous purchaser according to quality of sourcing data, a rate of data loss due to non-consent to resale during a distribution process, and contribution of a processor and/or an inspector involved in a provision process.

### Description of the Related Art

Crowdsourcing, a compound word of crowd and outsourcing, is a new business model that allows anyone to easily participate in data collection, refinement, processing, quality management, etc. through an online platform.

A platform for crowdsourcing serves as a channel that connects data providers and data processors for data processing, and is operated in a structure in which a provider recruits a worker through the platform to complete data, and the worker participates in a given project and earns a certain amount of profit.

A currently operating crowdsourcing platform is a limited structure that connects data providers and processors, and there is no case of providing a one-stop service covering data purchasers, providers, processors, and inspectors, which is a factor that hinders revitalization of data sourcing business.

In addition, so far, most of the artificial intelligence or big data companies have purchased crowdsourcing data as a one-time purchase through the platform, and there is no example of a service that induces the cost to be compensated through resale even when the cost is invested in the first purchase by aiding in reselling of the purchased data, which is another factor that hinders revitalization of data sourcing business.

In addition, from a point of view of data providers, a distribution process of data is not transparent, and thus the data providers tend to be reluctant to provide data. Furthermore, there is a thought that appropriate compensation for data provision is not being made, which is a major factor that hinders revitalization of sourcing business.

Korean Patent Laid-open Publication No. 10-2021-0059514 (May 25, 2021) relates to a media content sales system based on blockchain, which attempts vitalization of content distribution by paying compensation to purchasers of the corresponding content when a content sales amount reaches a preset target amount.

However, since compensation is paid only to purchasers, creators supplying content or editors increasing the value of content are omitted from compensation, which causes a problem in that vitalization of distribution is difficult to be expected. Further, since the content sales system corresponding to the platform owns the content, there is a problem of being exposed to legal issues such as copyright that may occur in a distribution process of the content.

### SUMMARY OF THE INVENTION

It is an object of the present invention to propose a method capable of inducing voluntary and active participation of data providers in a data sourcing business model.

It is another object of the present invention to propose a method capable of satisfying subjects of data providers, data purchasers, data sourcing platform operators, data processors, and data inspectors with reasonable compensation in a data sourcing business model.

It is a further object of the present invention to propose a method capable of allowing a data sourcing platform operator to be free from legal issues such as copyright in a process of processing, inspecting, and transmitting sourcing data.

The present invention proposes a blockchain-based data crowdsourcing and distribution method as a means to solve the above-mentioned problems.

In accordance with an aspect of the present invention, the above and other objects can be accomplished by the provision of a blockchain-based data crowdsourcing and distribution method including sourcing data supply to a plurality of provider terminals by a smart contractor of a data sourcing platform server when a purchase request including a specification of purchase-desired data is received from a purchaser terminal, storing received sourcing data in a distributed storage network when the sourcing data is received from the provider terminals by a cloud server connected to the platform server, generating, by a token generator of the platform server, a unit token including fungibility, ownership, a provider, a provider reward, a provider royalty, and a storage location for the distributed and stored individual sourcing data, and generating a data set token including a purchase price and a unit token ID of individual sourcing data for a data set in which the entire sourcing data is grouped, and executing, by the smart contractor, payment of a purchase price based on the data set token when all transaction conditions of the purchase request are satisfied, and paying rewards to providers of the individual sourcing data based on the unit token.

The blockchain-based data crowdsourcing and distribution method may further include querying, by an authenticator of the platform server, a provider of individual sourcing data included in a data set corresponding to an Nth purchase request whether to consent to data resale when the Nth purchase request including a specification of a purchase-desired data set is received from an Nth purchaser terminal (N being an integer greater than or equal to 2), generating, by the token generator, an Nth unit token and an Nth data set token for sourcing data of providers consenting the resale, and executing, by the smart contractor, payment of a purchase price based on the Nth data set token and paying royalties to providers of individual sourcing data based on the Nth unit token when all transaction conditions of the Nth purchase request are satisfied, wherein a payment manager of the platform server recalculates a purchase price presented by an Nth data purchaser based on the number of pieces of sourcing data excluded due to non-consent to the resale or a resale consent rate.

The blockchain-based data crowdsourcing and distribution method may further include generating, by the token generator, a unit token or an Nth unit token further including a processor, a processor reward, and a processor royalty for processed individual sourcing data when a data processing specification is included in the purchase request or the Nth purchase request, and paying, by the smart contractor, rewards or royalties to processors of individual sourcing data based on the unit token or the Nth unit token when all transaction conditions of the purchase request or the Nth purchase request are satisfied.

The blockchain-based data crowdsourcing and distribution method may further include generating, by the token generator, a unit token or an Nth unit token further including an inspector, an inspector reward, and an inspector royalty for inspected individual sourcing data when a data inspection specification is included in the purchase request or the Nth purchase request, and paying, by the smart contractor, rewards or royalties to inspectors of individual sourcing data based on the unit token or the Nth unit token when all transaction conditions of the purchase request or the Nth purchase request are satisfied.

The present invention proposes a blockchain-based data crowdsourcing and distribution system as another means to solve the above-mentioned problems.

In accordance with another aspect of the present invention, there is provided the system including a smart contractor configured to source data supply to a market provider terminal when a purchase request including a specification of purchase-desired data is received from a purchaser terminal, execute payment of a purchase price based on a data set token when all transaction conditions of the purchase request are satisfied, and execute reward payment of individual sourcing data based on a unit token, a data crowdsourcing platform server including a token generator configured to generate a unit token including fungibility, ownership, a provider, a provider reward, a provider royalty, and a storage location for the distributed and stored individual sourcing data, and to generate a data set token including a purchase price and a unit token ID of individual sourcing data for a data set in which the entire sourcing data is grouped, and a cloud server connected to the platform server and configured to store each piece of sourcing data included in received aggregated data in a distributed storage network when the aggregated data, which is a set of sourcing data of cloud providers, is received from the market provider terminal.

In the system, the platform server may further include an authenticator configured to query a provider of individual sourcing data included in a data set corresponding to an Nth purchase request whether to consent to data resale when the Nth purchase request including a specification of a purchase-desired data set is received from an Nth purchaser terminal (N being an integer greater than or equal to 2), the token generator may generate an Nth unit token and an Nth data set token for sourcing data of providers consenting the resale, the smart contractor may execute payment of a purchase price based on the Nth data set token and pays royalties to providers of individual sourcing data based on the Nth unit token when all transaction conditions of the Nth purchase request are satisfied, and the platform server may further include a payment manager configured to automatically recalculate a purchase price presented by an Nth data purchaser based on the number of pieces of sourcing data excluded due to non-consent to the resale or a resale consent rate.

When a data processing specification is included in the purchase request or the Nth purchase request, the token generator may generate a unit token or an Nth unit token further including a processor, a processor reward, and a processor royalty for processed individual sourcing data, and when all transaction conditions of the purchase request or the Nth purchase request are satisfied, the smart contractor may pay rewards or royalties to processors of individual sourcing data based on the unit token or the Nth unit token.

When a data inspection specification is included in the purchase request or the Nth purchase request, the token generator may generate a unit token or an Nth unit token further including an inspector, an inspector reward, and an inspector royalty for inspected individual sourcing data, and when all transaction conditions of the purchase request or the Nth purchase request are satisfied, the smart contractor may pay rewards or royalties to inspectors of individual sourcing data based on the unit token or the Nth unit token.

In the above-described embodiments, when sourcing data is stored in the distributed storage network, the cloud server may generate an identifier of the stored sourcing data, and then delete temporarily stored sourcing data from a cloud storage space.

In the above-described embodiments, the payment manager may determine a processor contribution rate using a processor contribution rate lookup table specifying processor contribution rates according to at least one of a processing specification, difficulty of processing, experience of a processor, or a processing request deadline presented by a purchaser, and determine the processor royalty based on a process-royalty table that matches the determined processor contribution rate and a royalty.

In the above-described embodiments, the payment manager may determine an inspector contribution rate using an inspector contribution rate lookup table specifying inspector contribution rates according to at least one of an inspection specification, difficulty of inspection, experience of an inspector, or an inspection request deadline presented by a purchaser, and determine the inspector royalty based on a verify-royalty table that matches the determined inspector contribution rate and a royalty.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an overall configuration diagram of a data crowdsourcing and distribution system according to an embodiment of the present invention;

FIG. 2 is a block diagram of a data sourcing platform server according to an embodiment;

FIG. 3 is a conceptual diagram illustrating a detailed configuration of a unit token and a data set token according to an embodiment;

FIG. 4 is a conceptual diagram illustrating a technical configuration when a data set is resold;

FIG. 5 is an overall configuration diagram of a data crowdsourcing and distribution system according to another embodiment of the present invention; and

FIG. 6 is an overall configuration diagram of a data crowdsourcing and distribution system according to still another embodiment of the present invention.

### DETAILED DESCRIPTION OF THE INVENTION

Hereinafter, several embodiments of the present invention will be described in detail using drawings. However, this is not intended to limit the present invention to any specific embodiment, and it should be understood that all transformations, equivalents, and substitutions including the technical idea of the present invention are included within the scope of the present invention.

In this specification, singular expressions encompass plural meanings unless the context clearly indicates otherwise.

In this specification, when a component is described as “having” or “comprising” a certain sub-component, this description does not exclude other components unless stated otherwise, and means that other components may be further included.

### First Embodiment

A first embodiment relates to a crowdsourcing-type data sourcing and distribution system that directly receives data from a plurality of data providers.

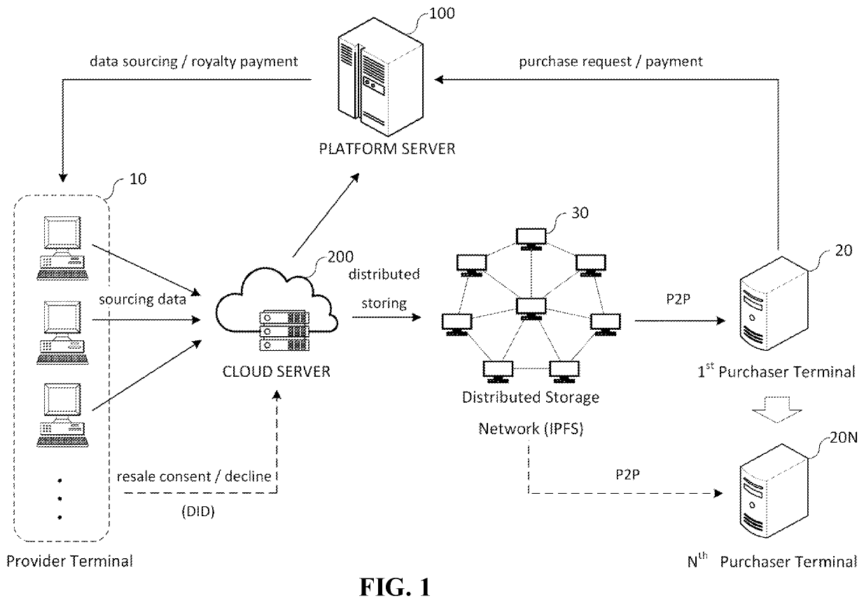

FIG. 1 is an overall configuration diagram of a data crowdsourcing and distribution system according to an embodiment.

The data crowdsourcing and distribution system according to the first embodiment includes a plurality of provider terminals 10, purchaser terminals 20 and 20N, a distributed storage network 30, a data sourcing platform server 100, and a cloud server 200.

Each of the provider terminals 10 is a computing device for newly generating sourcing data requested from the platform server 100 or acquiring the sourcing data from another device and transmitting the sourcing data to the cloud server 200.

Each of the purchaser terminals 20 and 20N is a computing device for requesting data sourcing from the platform server 100 using a blockchain-based smart contract, paying a data purchase price through the platform server 100 when a predetermined purchase condition is satisfied, and then receiving a data storage location from the platform server 100 to download desired data from the distributed storage network 30. The purchaser terminal 20N refers to a terminal for purchasing previously sold data again for the Nth time.

The provider terminals 10 and the purchaser terminals 20 and 20N are computing devices capable of accessing a remote server or terminal through a network, and examples thereof may include a desktop PC, a laptop PC, a tablet computer, a mobile cellular phone, and a wearable mobile device.

The distributed storage network 30 is a network for distributing and storing large amounts of data in storage nodes distributed around the world. A representative example may be an Inter Planetary File System (IPFS). However, the present is not limited thereto.

For reference, the IPFS generates blockchain blocks for distributing and storing ownership and data or content generated based on a non-fungible token (NFT), and each of the generated blocks includes transaction details, that is, transactions, within a certain period of time. The distributed storage network 30 uses the IPFS to issue a unique URL (hash value) of data or content to be distributed and stored in the blockchain network. The IPFS may deliver high-capacity files rapidly and efficiently (BitSwap), and know duplication of files, and thus may efficiently utilize a storage space (Merkle DAG, contents-addressed).

The data sourcing platform server 100 receives data purchase requests from the purchaser terminals 20 and 20N, sources data supply to the provider terminals 10 according to the received requests, executes payment when a predetermined purchase condition is satisfied, and pays rewards or royalties calculated according to various reference conditions to predetermined related entities.

Here, rewards are direct compensation for the labor of the executing entity, such as data generation by providers, data processing by processors, data inspection by inspectors, etc., and royalties are indirect compensation for values generated by such labor. Therefore, when the first purchase of sourcing data is made, a reward is paid to at least one of an original creator, a processor, or an inspector of the data, and when the Nth purchase is made through distribution (N being an integer greater than or equal to 2), a royalty is paid to at least one of the original creator, the processor, or the inspector of the data.

The cloud server 200 temporarily stores sourcing data transmitted from identified provider terminals 10 in a cloud storage space, extracts necessary information from the sourcing data or generates an identifier of the sourcing data, and then distributes and stores the sourcing data in the distributed storage network 30. The cloud server 200 may generate any one of a thumbnail image, a QR code, hash information of the sourcing data, or a partial excerpt of the sourcing data as an identifier of the sourcing data. However, the present invention is not limited to these examples, and any type of information for distinguishing sourcing data may be used as an identifier of the sourcing data. The generated identifier of the sourcing data may be shared with the platform server 100.

Meanwhile, the cloud server 200 preferably deletes temporarily stored sourcing data from the cloud storage space after storing the sourcing data in the distributed storage network 30. Sourcing data is not stored anywhere in the platform server 100 and the cloud server 200 of the present invention, and is stored only in the separately operated blockchain-based distributed storage network 30, and the data purchaser accesses the distributed storage network 30 using a Peer-to-Peer (P2P) method, not through the platform server 100 or the cloud server 200, and directly downloads the data, so that an operator of a data crowdsourcing and distribution platform system may be freed from legal issues of data ownership or copyright.

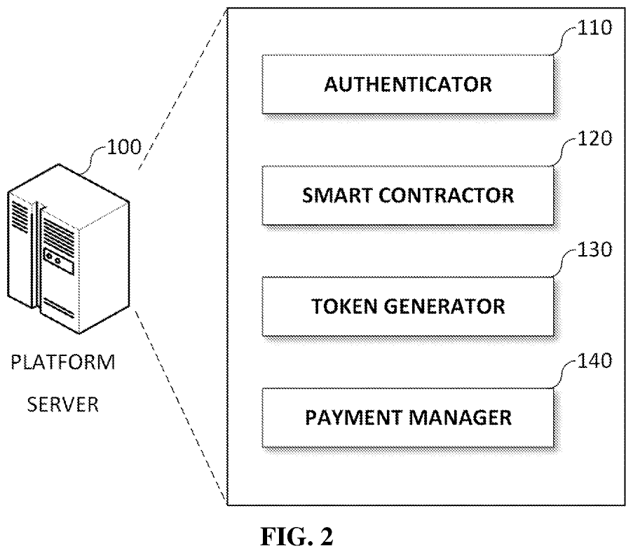

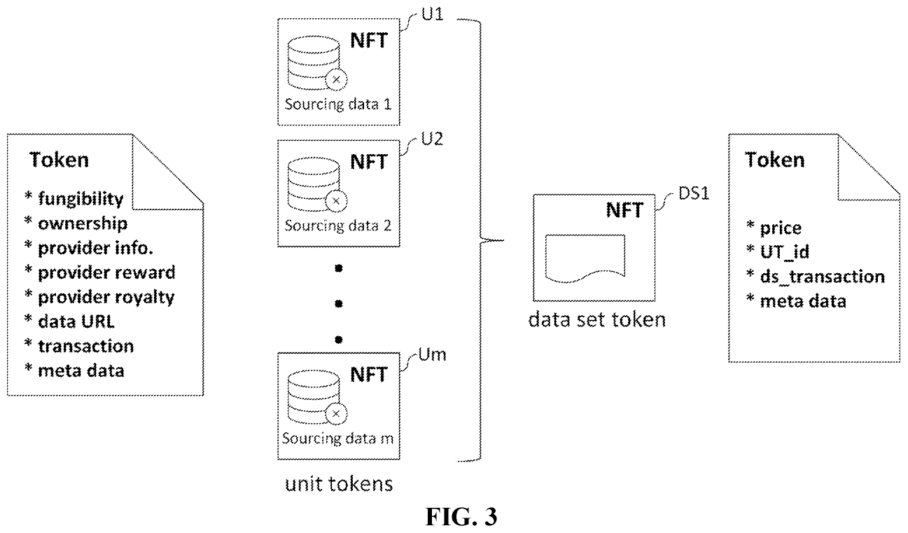

Hereinafter, the platform server 100 and the cloud server 200 will be described in more detail with reference to FIGS. 2 and 3.

FIG. 2 is a block diagram of the data sourcing platform server according to an embodiment.

As shown in FIG. 2, the data sourcing platform server 100 of the embodiment includes an authenticator 110, a smart contractor 120, a token generator 130, and a payment manager 140.

The authenticator 110 issues IDs for identification to a plurality of provides (or purchasers) to execute smart contacts between data providers and data purchasers, and performs authentication for each of the issued IDs using a predetermined authentication key. For example, the authenticator 110 issues a decentralized ID (DID) for authentication of a provider (or purchaser) and registers the issued DID in a blockchain network. Then, the identity of the provider is proved by verifying a public key included in a DID document of the provider stored in the blockchain network using an authentication key generated by a private key possessed by the provider having the DID issued.

The smart contractor 120 guarantees that a contract is automatically fulfilled for assets contained in a blockchain according to fulfillment of a condition given in advance. That is, the smart contractor 120 may be understood as a concept that combines two processes of establishment and execution of a contract into one process using blockchain technology by an automated self-enforced agreement.

Specifically, when a purchase request including a specification of purchase-desired data is received from the purchaser terminal 20, the smart contractor 120 sources data to be supplied to the plurality of provider terminals 10. Further, when all transaction conditions of the purchase request are satisfied, the purchase price is paid based on a data set token, and rewards or royalties are paid to providers of individual sourcing data based on a unit token.

Here, the specification of the purchase-desired data specifies a purchase condition of a data purchaser in detail, and the specification of the purchase-desired data may include, for example, at least one of a data type such as text/image/video/sound, required information to be included in the data, processing specification when processing of original data is desired, purchase price, or a delivery time.

The token generator 130 generates a unit token for distributed and stored individual source data and a data set token for a data set in which the entire source data is grouped.

FIG. 3 is a conceptual diagram illustrating a detailed configuration of a unit token and a data set token according to an embodiment.

As shown in FIG. 3, one unit token is generated for individual sourcing data, and at least one of fungibility, ownership, provider information, provider reward, provider royalty, storage location (data URL), data transaction history (d_transaction), or metadata is specified in each of unit tokens (U1 to Um).

However, it is unnecessary to be limited to these items. For example, when the unit token is implemented as an NFT, the detailed items of the unit token described above may be specified together or distributed in at least one of three parts of NFT Media Data, NFT Metadata, and NFT Smart Contract. In addition to these items, other items stipulated by the ERC-721 standard may be further specified.

Detailed items specified in the unit token are as follows.

That is, as fungible or non-fungible is specified in the fungibility item, the type of unit token is classified as a fungible token (FT) or an NFT. An owner or a copyright holder of data is specified in the ownership item. ID or DID information of the provider is specified in the provider item. A reward rate or reward amount to be paid to the provider is specified in the provider reward item. A royalty rate or royalty amount to be paid to the provider is specified in the provider royalty item. In the storage location (data URL), URLs for each piece of data of the sourcing data stored in the distributed storage network may be stored as a Merkle tree. A description for characterizing the sourcing data is specified in the metadata item of the unit token.

In addition, a data set token DS1 is generated for a data set in which a plurality of unit tokens U1 to Um is grouped, and at least one of purchase price (price), unit token ID (UT_id) of individual sourcing data, data set transaction history (ds_transaction), or metadata is specified in the data set token DS1.

In this instance, some information for distinguishing individual sourcing data may be stored as a Merkle tree in the unit token ID (UT_id) of the individual sourcing data. For example, Merkle root values specified in unit tokens of individual sourcing data may be stored as a Merkle tree in the unit token ID (UT_id) of the data set token.

In addition, despite the name, the unit token ID (UT_id) does not necessarily mean only identification information of a specific unit token. In other words, the unit token ID (UT_id) should be understood as a concept that includes any method or type of information necessary to find the storage location (data URL) of the individual sourcing data. Therefore, the data purchaser may use the unit token ID (UT_id) specified in the data set token DS1 to find out what the individual sourcing data included in the corresponding data set is and where the individual sourcing data is stored.

A description for characterizing the corresponding data set is specified in the metadata item of the data set token.

The payment manager 140 determines a reward or royalty of the individual sourcing data by applying a preset payment standard (payment default) to the purchase price specified in the purchase-desired data specification. The reward or loyalty standard may be set in advance as a payment ratio or a fixed payment amount.

The payment manager 140 may automatically analyze a degree to which the sourcing data provided by the provider matches the items specified in the purchase-desired data specification of the purchaser, and determine a quality level of the sourcing data according to an analysis result. In this case, the payment manager 140 may reflect the determined data quality level as a weight and calculate a result of multiplying the preset royalty standard by the weight for each data quality level as a reward or royalty of the corresponding sourcing data.

Next, the case where the initially sold data set is resold to another purchaser will be described in detail.

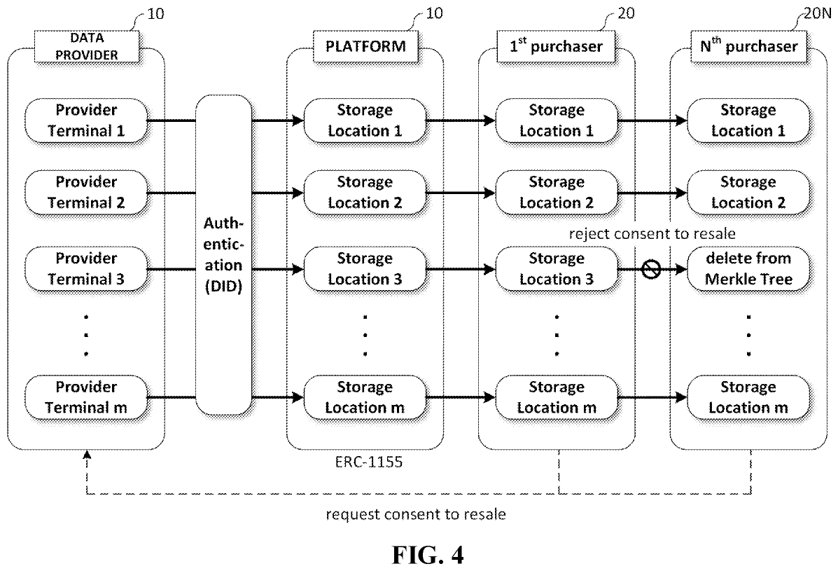

FIG. 4 is a conceptual diagram illustrating a technical configuration when a data set is resold.

As shown in FIGS. 1 and 4, there may be the case where, after a first purchaser purchases a first data set including m pieces of individual sourcing data (m being a positive integer greater than or equal to 2), a second purchaser repurchases the first data set.

When the smart contractor 120 receives an Nth purchase request including a specification of a purchase-desired data set from an Nth purchaser terminal (N being an integer greater than or equal to 2) 20N, the authenticator 110 queries a provider 10 of individual sourcing data included in a data set corresponding to the Nth purchase request whether to accept data resale, that is, whether to consent. Here, specification of the data set may include an identifier, a purchase price, and a delivery deadline of the data set desired to be purchased.

The token generator 130 generates an Nth unit token and an Nth data set token for sourcing data of providers consenting to resale. Here, specific constituent items of the Nth unit token and the Nth data set token are the same as those of the previously described unit token and data set token.

Specifically, the token generator 130 generates the Nth unit token by updating a provider royalty and a transaction history among constituent items of an (N−1)th unit token for the sourcing data of the providers consenting to resale.

In addition, as described above, some information for distinguishing individual sourcing data, for example, a Merkle root value specified in unit tokens, may be stored as a Merkle tree in the unit token ID (UT_id) of the individual sourcing data. In this case, the token generator 130 generates the Nth data set token by deleting a unit token ID (UT_id) node value for sourcing data of providers not consenting to resale from a Merkle tree of an (N−1)th dataset token, or inputting code of N/A (not applicable or garbage) promised in advance to the unit token ID (UT_id) to the corresponding node. As a result, an Nth data purchaser cannot find any clue to find sourcing data of a person not consenting to resale in the Nth data set token.

The payment manager 140 automatically recalculates the purchase price proposed by the Nth data purchaser based on the number of pieces of sourcing data excluded due to non-consent to resale or a resale consent rate. Preferably, the Nth purchase price may be recalculated lower than the purchase price as the number of providers not consenting to resale increases or as the resale consent rate decreases.

In addition, the payment manager 140 may recalculate rewards or royalties for providers consenting to resale based on the recalculated Nth purchase price based on the number of providers not consenting to resale or the resale consent rate.

When all the transaction conditions of the Nth purchase request are satisfied, the smart contractor 120 executes payment of the purchase price based on the Nth data set token with the purchase price updated, and pays royalties to providers of individual sourcing data based on each Nth unit token for which a royalty is updated.

### Second Embodiment

A second embodiment relates to a system in which at least one of a processor terminal or an inspector terminal is further added in the crowdsourcing-type data crowdsourcing and distribution system according to the first embodiment.

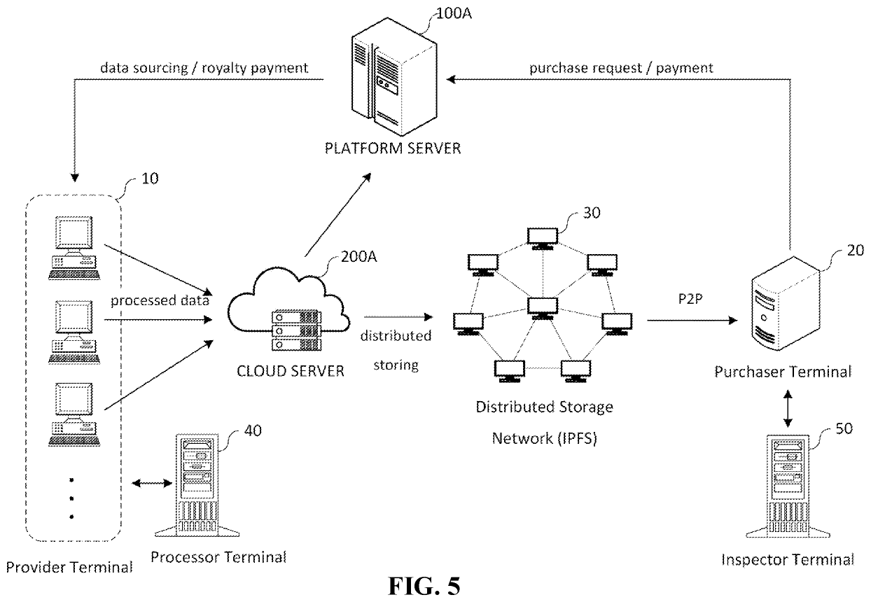

FIG. 5 is an overall configuration diagram of the data crowdsourcing and distribution system according to the second embodiment.

The data crowdsourcing and distribution system according to the second embodiment includes a plurality of provider terminals 10, purchaser terminals 20 and 20N, a distributed storage network 30, a data sourcing platform server 100A, and a cloud server 200. and further includes at least one of a processor terminal 40 or an inspector terminal 50.

In the second embodiment, since the provider terminals 10, the purchaser terminals 20 and 20N, the distributed storage network 30, and the cloud server 200 are the same as those in the above-described first embodiment, duplicate descriptions are omitted. In addition, the data sourcing platform server 100A is the same as the platform server 100 of the first embodiment except for the technical configuration associated with the processor terminal 40 or the inspector terminal 50, and hereinafter, a differentiated configuration due to addition of a processor and an inspector will be mainly described. Therefore, in a redundant description omitted from the second embodiment and the following description of the second embodiment, sourcing data may also be understood as processed data.

The processor terminal 40 processes original sourcing data upon request from any one of a purchaser, a provider, and a platform operator. For example, processing means removing personal information included in the original sourcing data, extracting essential information desired by the purchaser from the original sourcing data, extracting a target area desired by the purchaser when the original sourcing data is an image or video, extracting a target section desired by the purchaser from sound the original sourcing data is sound, etc.

A contribution rate of the processor may be determined depending on a type of processing, and a payment manager of the platform server 100A may possess a pre-constructed processor contribution rate lookup table for deriving a processor contribution rate according to at least one of processing specification, difficulty of processing, experience of a processor accepting a processing request, or a processing request deadline presented by the purchaser.

A specific requirement may be specified in a processing specification among purchase-desired data specifications submitted by the provider to the platform server 100A. The platform server 100A may send the processing specification to at least one of processing terminals listed in a pre-constructed processor database, or deliver the processing specification when sourcing data supply to the plurality of provider terminals 10, so that processing is performed through a processor linked to the provider terminals 10.

When a data processing specification is included in a first purchase request or an Nth purchase request from the purchaser, a token generator of the platform server 100A generates a unit token or an Nth unit token further including a processor, a processor reward, and a processor royalty for individual sourcing data processed by the processor.

That is, the unit token or the Nth unit token generated for the processed data of the second embodiment includes at least one of fungibility, ownership, provider, provider royalty, processor, processor royalty, storage location, sourcing data transaction history, or metadata.

The payment manager of the platform server 100A determines the processor reward based on the processor contribution rate lookup table and a process-reward table that matches a contribution rate and a reward of a processor for each processing type.

In addition, the payment manager of the platform server 100A determines the processor royalty based on the processor contribution rate lookup table and a process-royalty table that matches a contribution rate and a royalty of a processor for each processing type.

Next, the inspector terminal 50 inspects the processed data upon request from any one of the purchaser, the provider, and the platform operator. Inspection is a process of evaluating whether or not the processed data subject to delivery matches the data type, required information, and processing specification among purchase-desired data request specifications presented by the purchaser, or a degree of matching, as a level or a score.

A contribution rate of the inspector may be determined according to an aspect of inspection, and the payment manager of the platform server 100A may construct in advance an inspector contribution rate lookup table capable of deriving an inspector contribution rate according to at least one of an inspection specification, inspection difficulty, experience of an inspector accepting an inspection request, or an inspection request deadline presented by the purchaser.

A specific requirement may be specified in the inspection specification among the purchase-desired data specifications submitted by the provider to the platform server 100A. The platform server 100A may send the inspection specification to at least one of inspector terminals listed in a pre-constructed inspector database.

When a data inspection specification is included in a first purchase request or an Nth purchase request of the purchaser, the token generator of the platform server 100A generates a unit token or an Nth unit token further including an inspector, an inspector reward, and an inspector royalty for individual sourcing data inspected by the inspector.

That is, the unit token or the Nth unit token generated for the individual sourcing data of the second embodiment includes at least one of fungibility, ownership, provider, provider royalty, inspector, inspector royalty, storage location, sourcing data transaction history, or metadata.

The payment manager of the platform server 100A automatically determines the inspector reward based on the inspector contribution rate lookup table and a verify-reward table that matches a contribution rate and a reward of an inspector for each inspection type.

In addition, the payment manager of the platform server 100A automatically determines the inspector royalty based on the inspector contribution rate lookup table and a verify-royalty table that matches a contribution rate and a royalty of an inspector for each inspection type.

### Third Embodiment

A third embodiment relates to a data market-type data crowdsourcing and distribution system in which a representative data provider receives and aggregates data from a plurality of other providers and then supplies aggregated data sets in batches.

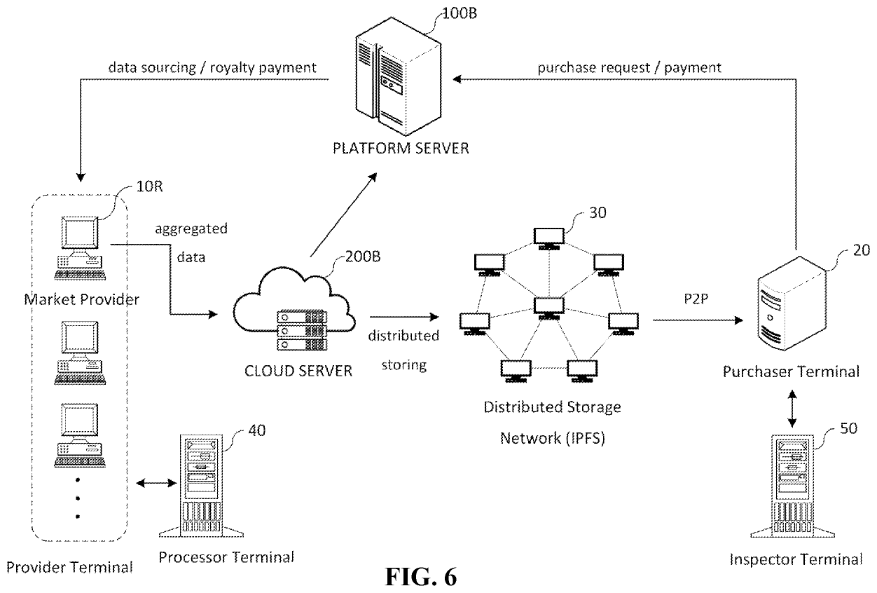

FIG. 6 is an overall configuration diagram of the data crowdsourcing and distribution system according to the third embodiment.

The data crowdsourcing and distribution system according to the third embodiment includes a market provider terminal 10R, purchaser terminals 20 and 20N, a distributed storage network 30, a data sourcing platform server 100B, and a cloud server 200B.

In the third embodiment, since the purchaser terminals 20 and 20N, the distributed storage network 30, and the cloud server 200 are the same as those in the above-described first embodiment or second embodiment, duplicate descriptions are omitted.

The market provider terminal 10R may be understood as a terminal of a market operator specializing in data sourcing.

When the platform server 100B transmits sourcing of data supply, the market provider terminal 10R sources data supply again by utilizing a self-constructed provider pool, and when data is collected from a plurality of provider terminals, the platform server 100B transmits aggregated data including collected sourcing data and provider information to the cloud server 200B.

The cloud server 200B classifies a plurality of pieces of sourcing data for each provider by referring to provider information in the aggregated data, and stores each piece of the classified sourcing data in the distributed storage network 30.

The provider information in the aggregated data is shared with the platform server 100B, and each of an authenticator, a token generator, and a payment manager of the platform server 100B performs authentication and consent query for individual providers during Nth resale, generates a unit token, an Nth unit token, and a data set token for the individual providers, and calculates and pays royalties for the individual providers based on the provider information in the aggregated data. Other technical configurations of the platform server 100B are the same as those of the first embodiment and the second embodiment.

Lastly, in the embodiments described above, setting of royalties may be modified and implemented in various forms.

That is, in another embodiment, the royalty manager may increase the royalty paid to the purchaser terminal as the number of ownership transfer contracts increases.

For example, when the number of ownership transfer contracts for data registered in the provider terminal is 10 or less, the royalty may be set to 5%, and when the number exceeds 10, the royalty may be set to 10%.

In another embodiment, when the first purchaser terminal purchasing raw original data simply processes the original data and resells the original data to the second purchaser terminal, a payment rate of a royalty paid to the provider terminal may be set high. In other words, the royalty manager pays a higher royalty for simply processed data to the provider terminal providing the original data than to the first seller.

In another embodiment, when the first purchaser terminal purchasing raw original data resells the original data after rearranging the original data, changing details thereof, or performing processing thereon, the royalty manager sets a payment rate of a royalty paid to the first purchaser terminal to be high. For example, when a value of data increases due to change or processing of the data, the royalty manager may decrease a royalty rate paid to the provider terminal providing the original data and increase a royalty rate paid to a first seller generating the processed data.

In another embodiment, the royalty manager may set a purchaser terminal purchasing changed or processed data for an Nth time to pay royalties to previous purchaser terminals selling the data after changing or processing the data. For example, a purchaser terminal purchasing processed data for a fourth time may be set to pay royalties to a first purchaser terminal to a third purchaser terminal processing the data.

At this time, when the second purchaser terminal sells the data processed by the first purchaser terminal to the third purchaser terminal without further processing, royalty payment to the second purchaser terminal may be invalidated.

In the above-described embodiments, the provider terminals 10 and 10A, the purchaser terminals 20 and 20N, the distributed storage network 30, the processor terminal 40, the inspector terminal 50, the data sourcing platform server 100, and the cloud server 200 are connected to each other through a wired or wireless network. The network refers to a connection structure that enables mutual information exchange between respective constituent nodes such as a plurality of terminals and servers. Specific examples of the network may include a radio frequency (RF) network, a third-generation partnership project (3GPP) network, a long-term evolution (LTE) network, a fifth-generation partnership project (5GPP) network, a world interoperability for microwave access (WIMAX) network, the Internet, a local area network (LAN), a wireless local area network (wireless LAN), a wide area network (WAN), a personal area network (PAN), a Bluetooth network, an NFC network, a satellite broadcasting network, an analog broadcasting network, a digital multimedia broadcasting (DMB) network, etc. However, the present invention is not limited thereto.

The invention related to the method among the above-described embodiments may be implemented as a computer program. In other words, the present invention may be implemented as an application software program running on mobile terminals such as smartphones and tablets based on Google's Android or Apple's iOS, may be implemented as an application software program running on wearable devices such as Google Glass, Apple Watch, Samsung Galaxy Watch, smartwatch, etc., or may be implemented as a software program for a laptop PC or desktop PC running based on Microsoft's Windows or Google's Chrome OS.

Partial functions of the above-described device or system may be provided by being included in a recording medium readable by a computer by tangibly implementing a program of instructions for implementing the functions. Examples of the computer-readable recording medium may include magnetic media such as hard disks, floppy disks, and magnetic tapes, optical media such as CD-ROMs and DVDs, magneto-optical media such as floptical disks, a ROM, a RAM, a flash memory, a USB memory, etc.

According to embodiments of the present invention, a reasonable level of royalty compensation is provided to all data providers, data purchasers, data sourcing platform operators, data processors, and data inspectors in a data sourcing business model, and thus it is possible to induce voluntary and active participation by those involved in the business.

In addition, according to embodiments of the present invention, a data sourcing platform operator does not directly store sourcing data in a process of processing, inspecting, and transmitting the sourcing data, and only maintains minimum information required for sourcing and distribution, and thus may be free from legal issues such as copyright.

Even though the present invention has been described above with reference to several embodiments, those of ordinary skill in the same or similar technical fields may variously modify and change the present invention without departing from the spirit and scope of the present invention as set forth in the claims.

What is claimed is:

1. A blockchain-based data crowdsourcing and distribution method comprising:
sourcing data supply to a plurality of provider terminals by a smart contractor of a data sourcing platform server when a purchase request including a specification of purchase-desired data is received from a purchaser terminal;
storing received sourcing data in a distributed storage network when the sourcing data is received from the provider terminals by a cloud server connected to the platform server;
generating, by a token generator of the platform server, a unit token including fungibility, ownership, a provider, a provider reward, a provider royalty, and a storage location for the distributed and stored individual sourcing data, and generating a data set token including a purchase price and a unit token ID of individual sourcing data for a data set in which the entire sourcing data is grouped; and
executing, by the smart contractor, payment of a purchase price based on the data set token when all transaction conditions of the purchase request are satisfied, and paying rewards to providers of the individual sourcing data based on the unit token.

2. The blockchain-based data crowdsourcing and distribution method according to claim 1, wherein, when sourcing data is stored in the distributed storage network, the cloud server generates an identifier of the stored sourcing data, and then deletes temporarily stored sourcing data from a cloud storage space.

3. The blockchain-based data crowdsourcing and distribution method according to claim 1, further comprising analyzing, by a payment manager of the platform server, a matching level of sourcing data of the provider and the specification of the purchase-desired data to determine a quality level of the sourcing data, and determining the provider reward or the provider royalty based on the determined quality level.

4. The blockchain-based data crowdsourcing and distribution method according to claim 1, further comprising:
querying, by an authenticator of the platform server, a provider of individual sourcing data included in a data set corresponding to an Nth purchase request whether to consent to data resale when the Nth purchase request including a specification of a purchase-desired data set is received from an Nth purchaser terminal (N being an integer greater than or equal to 2);
generating, by the token generator, an Nth unit token and an Nth data set token for sourcing data of providers consenting the resale; and
executing, by the smart contractor, payment of a purchase price based on the Nth data set token and paying royalties to providers of individual sourcing data based on the Nth unit token when all transaction conditions of the Nth purchase request are satisfied,
wherein a payment manager of the platform server recalculates a purchase price presented by an Nth data purchaser based on the number of pieces of sourcing data excluded due to non-consent to the resale or a resale consent rate.

5. The blockchain-based data crowdsourcing and distribution method according to claim 4, further comprising:
generating, by the token generator, a unit token or an Nth unit token further comprising a processor, a processor reward, and a processor royalty for processed individual sourcing data when a data processing specification is included in the purchase request or the Nth purchase request; and
paying, by the smart contractor, rewards or royalties to processors of individual sourcing data based on the unit token or the Nth unit token when all transaction conditions of the purchase request or the Nth purchase request are satisfied.

6. The blockchain-based data crowdsourcing and distribution method according to claim 5, wherein the payment manager determines a processor contribution rate using a processor contribution rate lookup table specifying processor contribution rates according to at least one of a processing specification, difficulty of processing, experience of a processor, or a processing request deadline presented by a purchaser, and determines the processor royalty based on a process-royalty table that matches the determined processor contribution rate and a royalty.

7. The blockchain-based data crowdsourcing and distribution method according to claim 4, further comprising:
generating, by the token generator, a unit token or an Nth unit token further comprising an inspector, an inspector reward, and an inspector royalty for inspected individual sourcing data when a data inspection specification is included in the purchase request or the Nth purchase request; and
paying, by the smart contractor, rewards or royalties to inspectors of individual sourcing data based on the unit token or the Nth unit token when all transaction conditions of the purchase request or the Nth purchase request are satisfied.

8. The blockchain-based data crowdsourcing and distribution method according to claim 7, wherein the payment manager determines an inspector contribution rate using an inspector contribution rate lookup table specifying inspector contribution rates according to at least one of an inspection specification, difficulty of inspection, experience of an inspector, or an inspection request deadline presented by a purchaser, and determines the inspector royalty based on a verify-royalty table that matches the determined inspector contribution rate and a royalty.

9. A blockchain-based data crowdsourcing and distribution platform system, comprising:
a smart contractor configured to source data supply to a market provider terminal when a purchase request including a specification of purchase-desired data is received from a purchaser terminal, execute payment of a purchase price based on a data set token when all transaction conditions of the purchase request are satisfied, and execute reward payment of individual sourcing data based on a unit token;
a data crowdsourcing platform server comprising a token generator configured to generate a unit token including fungibility, ownership, a provider, a provider reward, a provider royalty, and a storage location for the distributed and stored individual sourcing data, and to generate a data set token including a purchase price and a unit token ID of individual sourcing data for a data set in which the entire sourcing data is grouped; and
a cloud server connected to the platform server and configured to store each piece of sourcing data included in received aggregated data in a distributed storage network when the aggregated data, which is a set of sourcing data of cloud providers, is received from the market provider terminal.

10. The blockchain-based data crowdsourcing and distribution platform system according to claim 9, wherein, when sourcing data is stored in the distributed storage network, the cloud server generates an identifier of the stored sourcing data, and then deletes temporarily stored sourcing data from a cloud storage space.

11. The blockchain-based data crowdsourcing and distribution platform system according to claim 9, wherein the platform server further comprises a payment manager configured to analyze a matching level of sourcing data of the provider and the specification of the purchase-desired data to determine a quality level of the sourcing data, and to determine the provider reward or the provider royalty based on the determined quality level.

12. The blockchain-based data crowdsourcing and distribution platform system according to claim 9, wherein:
the platform server further comprises an authenticator configured to query a provider of individual sourcing data included in a data set corresponding to an Nth purchase request whether to consent to data resale when the Nth purchase request including a specification of a purchase-desired data set is received from an Nth purchaser terminal (N being an integer greater than or equal to 2),
the token generator generates an Nth unit token and an Nth data set token for sourcing data of providers consenting the resale,
the smart contractor executes payment of a purchase price based on the Nth data set token and pays royalties to providers of individual sourcing data based on the Nth unit token when all transaction conditions of the Nth purchase request are satisfied, and
the platform server further comprises a payment manager configured to automatically recalculate a purchase price presented by an Nth data purchaser based on the number of pieces of sourcing data excluded due to non-consent to the resale or a resale consent rate.

13. The blockchain-based data crowdsourcing and distribution platform system according to claim 9, wherein:
when a data processing specification is included in the purchase request or the Nth purchase request, the token generator generates a unit token or an Nth unit token further comprising a processor, a processor reward, and a processor royalty for processed individual sourcing data, and
when all transaction conditions of the purchase request or the Nth purchase request are satisfied, the smart contractor pays rewards or royalties to processors of individual sourcing data based on the unit token or the Nth unit token.

14. The blockchain-based data crowdsourcing and distribution platform system according to claim 13, wherein the payment manager determines a processor contribution rate using a processor contribution rate lookup table specifying processor contribution rates according to at least one of a processing specification, difficulty of processing, experience of a processor, or a processing request deadline presented by a purchaser, and determines the processor royalty based on a process-royalty table that matches the determined processor contribution rate and a royalty.

15. The blockchain-based data crowdsourcing and distribution platform system according to claim 9, wherein:
when a data inspection specification is included in the purchase request or the Nth purchase request, the token generator generates a unit token or an Nth unit token further comprising an inspector, an inspector reward, and an inspector royalty for inspected individual sourcing data, and
when all transaction conditions of the purchase request or the Nth purchase request are satisfied, the smart contractor pays rewards or royalties to inspectors of individual sourcing data based on the unit token or the Nth unit token.

16. The blockchain-based data crowdsourcing and distribution platform system according to claim 15, wherein the payment manager determines an inspector contribution rate using an inspector contribution rate lookup table specifying inspector contribution rates according to at least one of an inspection specification, difficulty of inspection, experience of an inspector, or an inspection request deadline presented by a purchaser, and determines the inspector royalty based on a verify-royalty table that matches the determined inspector contribution rate and a royalty.
